(19) United States
(12) Patent Application Publication
(10) Pub. No.: US 2007/0199404 A1
(43) Pub. Date: Aug. 30, 2007

(54) Differential locking system

(75) Inventor: Kevin Andrew Mason, Godalming (GB)

Correspondence Address: ANTHONY R. BARKUME, 20 GATEWAY LANE, MANORVILLE, NY, 11949, US

(73) Assignee: KAM DIFFERENTIALS LTD., Godalming (GB)

(21) Appl. No.: 10/598,410

(22) PCT Filed: Feb. 25, 2005
(86) PCT No.: PCT/GB05/00701

§ 371 Date: Aug. 28, 2006

(30) Foreign Application Priority Data
Feb. 28, 2004 (GB) 0404547.2

(51) Int. Cl. F16H 57/02

(52) U.S. Cl. 74/607

(57) ABSTRACT

A system of mounting differential locking devices onto a range of vehicles, be it new vehicles or retro fitting onto existing older vehicles, by means of mounting the locking assembly under a removable diff cover. A shaped mounting ring is fixed onto the rear of the axle assembly, in place of a conventional diff pan. A removable diff cover, which is sufficiently shaped or enlarged to accept the locking actuator, is fitted to the mounting ring, encasing the whole diff and diff locking assembly. A solenoid (or other mechanical actuator device) is mounted inside the shaped ring, parallel to the half shaft. The solenoid is connected to a fork, which in turn communicates reciprocal movement which engages/disengages a sliding dog gear into a splined bearing journal, press fitted into the diff carrier. This action causes the opposing half shafts to be locked together or independent as desired.

This invention relates to a differential locking device for use with vehicles and to a method of installing a differential locking device onto a range of vehicle axles.

The differential locking assembly is an already well known and reliable component, particularly in the field of off road and agricultural vehicles. Many vehicles though, that are used for this type of work do not have them fitted and would greatly benefit by having them.

The after market differential locking systems presently available tend to be complicated and/or costly to produce and fit, particularly in the case of pneumatic, vacuum or cable systems. Also, the proposed system is not intrusive to the axle tubing itself, and therefore does not interfere with structural integrity of the axle assembly.

It is a feature of the present invention that it can provide a simple, cheap to produce device and system which is easy to install and, once fitted, is easy to inspect and adjust. The positioning of the locking assembly also has the advantage of not fouling any exhaust, brake line or suspension components etc. The system may also apply to a range of vehicles, be it new vehicles or retro fitting onto existing older vehicles.

The invention provides a differential pan removably attachable to a vehicle to cover the differential unit of the vehicle and a locking device able to be fitted to the differential unit of the vehicle in which, when the differential pan is attached to the vehicle, the locking device can be attached to the vehicle differential unit inside the differential pan.

Mounting a locking assembly under a removable differential cover creates an environment within the differential housing assembly, which has previously not been available, namely an area suitable to fit a differential locking device.

In a preferred method of installing the device of the invention to a vehicle a shaped mounting ring is fixed (preferably welded) onto the rear of the axle assembly of the vehicle, in place of the conventional differential pan. A removable differential cover, which is also sufficiently large enough to accept the complete locking assembly and actuator, is fitted to the mounting ring, encasing the entire assembly. A solenoid (or other mechanical actuator device) is mounted inside the shaped ring, parallel to the half shaft of the vehicle to operate the locking device. The solenoid is connected to a fork, which in turn communicates reciprocal movement which engages/disengages a sliding dog gear (splined to the half shaft) into a splined bearing journal located in the differential carrier. This action causes the opposing half shafts to be locked together or independent as desired.

A switching device such as a microswitch, can easily be fitted inside the diff casing and can be used warn the vehicles driver of the operational status of the differential locker, for example: a lamp may be illuminated or a warning alarm may sound when the locker is engaged. The switch may be operated by the reciprocal movement of the solenoid or actuator. The mounting for the switch may be incorporated into the differential carrier's bearing adjuster locking tab fixing point, by means of combining the switch mounting plate with the locking tab. It may also be fitted in any other position suitable for the available space constraints. Another method for operating the warning device could employ a current sensor on the solenoid wiring.

It is a feature of the present invention that it is cheap to produce with very few components; it is versatile and can be fitted to the majority of different vehicles; can be installed on new vehicles or retrofitted. It is easy to install and easy to inspect and adjust after assembly. Safety features which can be included are that, when the power is off, the device is unlocked and there can be an optional manual override.

A specific embodiment of the system will now be described by way of an example, with reference to the accompanying drawings. A retrofit example will be described herein, but the same basic procedures and functions would also apply to production line new vehicles.

In the drawings

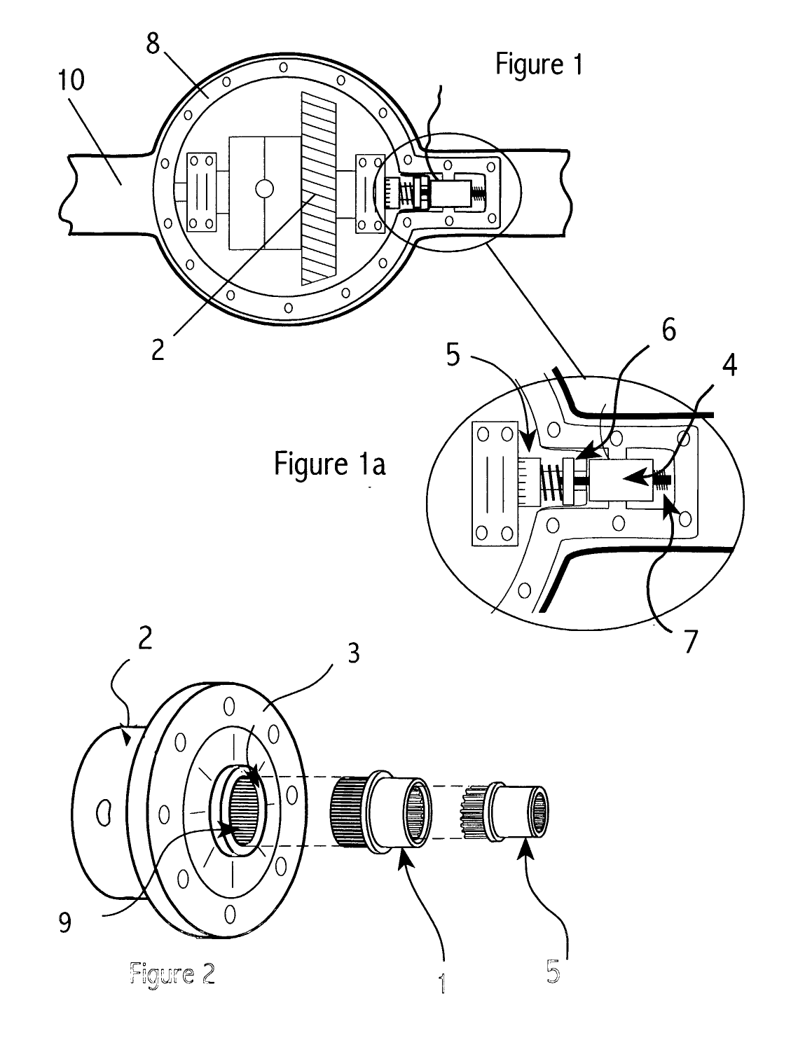

FIG. 1 is a plan view of the device looking from the rear of the axle, with cover removed.

FIG. 2 is a view of the splines and locking components

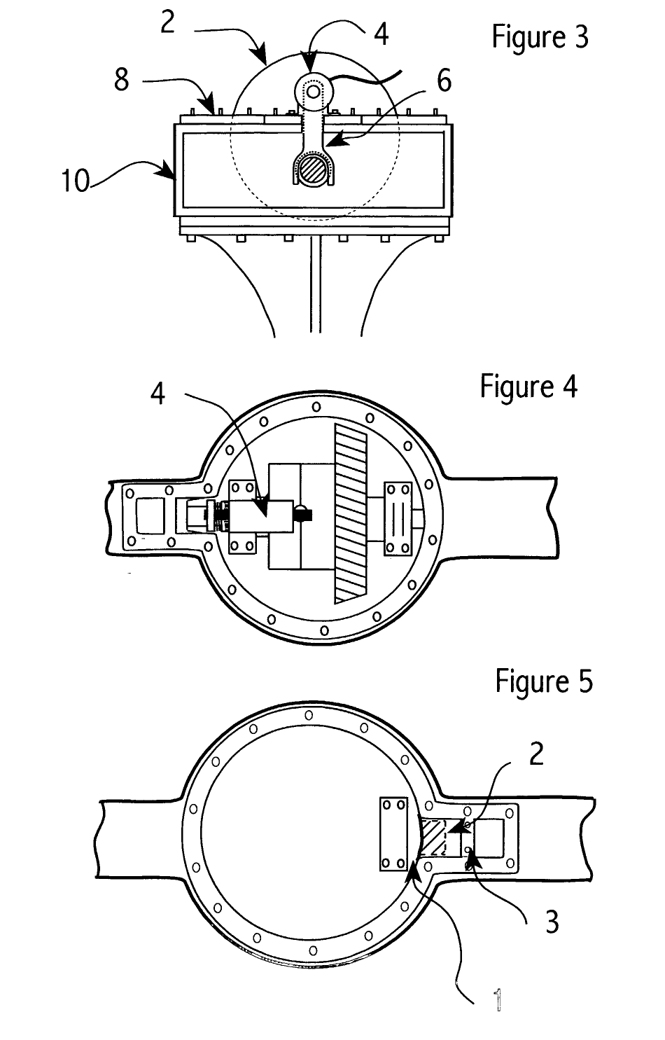

FIG. 3 is a view of the actuator fork assembly

FIG. 4 is a view of an alternative mounting position for the actuator; i.e. on the differential carrier bearing.

FIG. 5 shows material removed from the axle casing

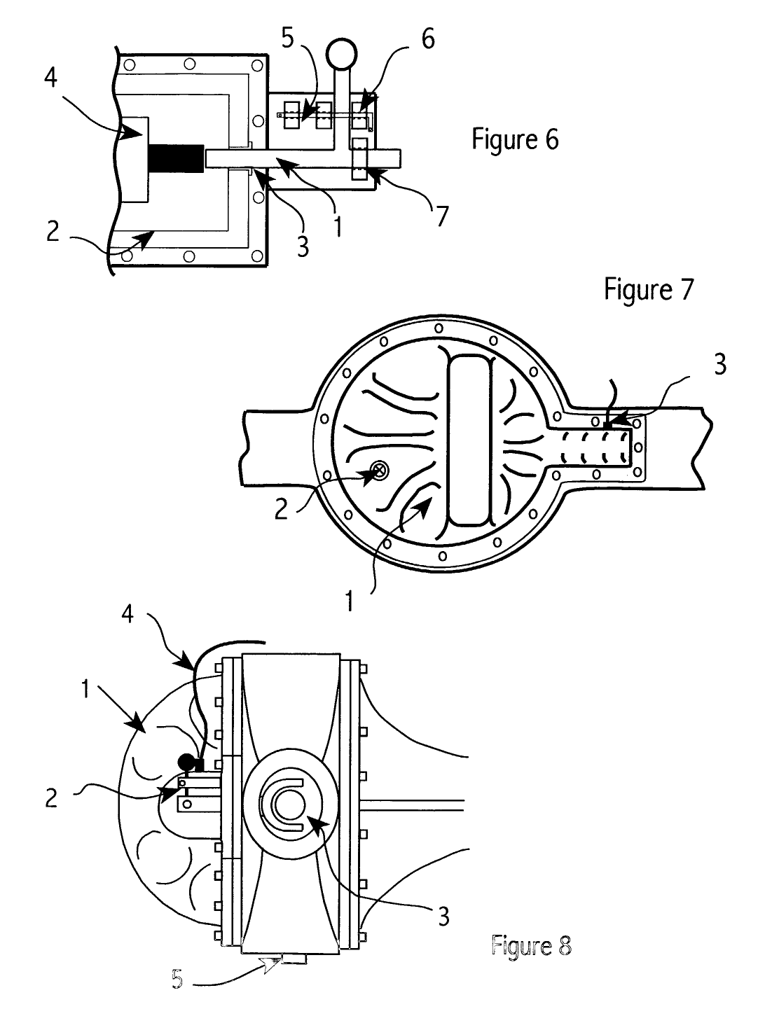

FIG. 6 is a view of a manual override and

FIGS. 7 and 8 shows a shaped differential pan.

Referring to FIGS. 1 to 4 the differential carrier core assembly (2) is fitted with a splined bearing journal (1) at one end. This journal will perform for both the diff carrier core and associated sun gear. This can be achieved by machining off the original bearing journal at (3), internally splining the remaining casting (2) at position (9) and press fitting (interference fit) an externally splined bearing journal (1). A special half shaft is fitted with a lengthened spline shaft at the differential end. A sliding dog gear (5) with internal splines to match the half shaft is fitted onto the half shaft upon assembly. It also has external splines to match the differential carrier splines, (although in some cases it is also preferable to have external splines on the differential carrier on an extended journal, and matching internal splines on the sliding dog.) The purpose of this sliding dog gear is to allow the half shaft to be connected to the differential carrier. The splines on the bearing journal and sliding dog are designed to easily mate.

To engage the differential lock, the sliding dog is forced inwards along the half shaft spline and locks into the spline previously mentioned in the differential carrier. This causes the two half shafts to be locked together, to create an even amount of drive to both connected half shafts, and thus turn the vehicle wheels evenly. The sliding dog's movement in the example is caused by an electric solenoid (4), (FIG. 3) (but any conventional assembly will also work), positioned parallel to the half shaft, mounted either above the differential carrier bearing (4) (FIG. 4), or (as in this example) onto axle casing, opposed to the differential carrier (FIG. 1A). Movement to the dog is communicated via a fork (6) connected to the solenoid.

The solenoid preloads a spring mounted in front of the fork (6) which in turn, transfers its energy to engage the dog gear into the differential carrier spline. A return spring is also installed to aid disengagement, in this example at (7).

To allow the above to be fitted into a conventional banjo type axle assembly, the old differential pan must firstly be removed (or not fitted in the case of a new vehicle). A special differential pan mounting ring (8), which is shaped to allow the fitment of the solenoid or actuator, is then fitted to the axle casing (10), in place of the old differential pan. This can have either threaded holes, studs or similar mountings attached and must be substantial enough to reinforce the axle casing. If the ring is to be welded to the axle, mounting studs for the differential pan can be used to lift the ring away from the axle to create a space suitable for a welding bead, by protruding through the bottom of the ring. The axle assembly can then be reinstalled with differential and locking assembly.

Referring to FIG. 5 in some cases there is not enough clearance between the axle housing and the differential bearing cap (1) to allow the fork to move fully. In these cases material can safely be removed from the axle casing (2), as the new differential pan mounting ring also acts as a reinforcing plate. The solenoid may also be mounted on the ring at (3).

In the case of axles that already have removable differential pans, an adaptor plate may be fitted, utilising the existing holes in the axle case, to allow the new type of differential cover to be fitted, thus giving the space and environment needed to install the system as described.

Referring to FIGS. 7 and 8 a new shaped differential pan can then fitted, (1) along with a suitable gasket material, which allows the locking assembly to fit and operate. A simple electronic switch can be used to operate the system, via a warning lamp and relay. The wiring must also be water resistant and located in such a position to not let water into differential case or let oil out. An oil level plug to allow for new level of oil should also be added (2).

Referring to FIG. 6 a manual override can also be added to the unit. An example of this is to add a protruding rod (1) through the differential cover (2) & seal (3), which would communicate linear movement to the solenoid or actuator (4), which in turn would manually engage or disengage the locking dog, by locking lever (1) (through bush (7) in place by use of locking pin (5), into slots (6). This may be desirable in the case of an electrical failure within the vehicle.

It is proposed that ABS plastic would be a suitable material for the new differential pan, but steel or another material (such as Aluminium or Polycarbonate) may also be practicable. If ABS is used, a steel guard may be desired. This could be fitted to the differential pan mounting ring giving additional strength to the differential pan. Reinforcing webs would also be a desired feature, adding strength to the pan. The pan should also be made such that is can be used to cover the solenoid (or actuator) when it is fitted to either above the bearing caps or onto the axle casing.

Referring to FIG. 8 a magnetic sump plug (5) may also be added to ensure metallic particles do not foul in the solenoid and/or locking mechanist

1-31. (canceled)

32. A differential pan removeably attachable to a vehicle to cover the differential unit of the vehicle and a locking device able to be fitted to the differential unit of the vehicle, the arrangement being such that when the locking device is fitted to the differential unit and the differential pan is attached to the vehicle, the differential unit and the locking device are inside the differential pan.

33. A differential pan as claimed in claim 32, in which the locking device includes a mechanical actuator which acts on the locking device to operate the locking device.

34. A differential pan as claimed in claim 33, in which the actuator includes a solenoid.

35. A differential pan as claimed in claim 32, in which the actuator is adapted to be mounted on the axle casing, within the differential pan area.

36. A differential pan as claimed in claim 32, in which the actuator is adapted to be mounted on a differential pan mounting ring.

37. A differential pan as claimed claim 32, in which the locking device comprises a fork which is able to communicate reciprocal movement which engages/disengages a sliding dog gear, splined to the half shaft of the vehicle, into a splined bearing journal located in the differential carrier.

38. A differential pan as claimed in claim 32, in which there is a ring with an additional protrusion which can be fitted to the axle assembly to act as a mounting stage for an extended differential pan.

39. A differential pan as claimed in claim 32, which is constructed from an acrylonitrile/butadiene/styrene (ABS) plastics material

40. A vehicle having an axle incorporating:
(i) a differential unit comprising a differential housing and a differential pan removeably attached to the differential housing to cover the differential unit of the vehicle; and
(ii) a locking device fitted to the differential unit of the vehicle;
wherein the differential pan accommodated the locking device.

41. A vehicle as claimed in claim 40, wherein the differential pan has an extended area to accommodate part of the locking device.

42. A vehicle as claimed in claim 41, in which there is a ring with an additional protrusion, which is fitted to the axle assembly, which acts as a mounting stage for the extended differential pan.

43. A vehicle as claimed in claims 40, in which there is a press-in bearing journal fitted into the differential carrier core, which incorporates a splined locking portion and also acts as a bearing journal for the sun gear of the differential unit.

44. A vehicle as claimed in claim 40, including a manual override for the locking device.

45. A vehicle as claimed in claim 40, in which the actuator is mounted on a support selected from the group consisting of the differential unit bearing cap, the axle casing, within the differential pan area, and the differential pan mounting ring.

46. A vehicle as claimed in claim 40, in which the differential pan is removable to set up, inspect and/or adjust the differential lock assembly.

47. A vehicle as claimed in claim 40, in which the axle casing material is reduced under differential pan to allow for locking component movement.

48. A vehicle as claimed in claim 40, in which a differential pan mounting ring is used as reinforcement to the axle assembly.

49. A vehicle as claimed in claim 40, in which there is a removable differential guard mounted onto the differential pan mounting ring bolts.

50. A vehicle as claimed in claim 40, in which there are mounting studs used to create a space between mounting ring and axle assembly suitable for welding.

51. A vehicle as claimed in claim 40, where reciprocal movement caused by an actuator positioned under a removeably attachable cover is employed to warn the operator of the operational status of the actuator.

52. A vehicle as claimed in claim 40, where a switch mounting plate combined with a bearing adjuster locking tab is employed.

53. A vehicle as claimed in claim 40, where a switching device is mounted inside the shaped ring to communicate operational status or position of the actuator.

54. A method for converting a non-locking differential for a vehicle to a locking differential, said non-locking differential having a differential housing and a differential pan removeably mounted thereon, which method comprises the steps of:
(i) removing the existing differential pan;
(ii) modifying and/or replacing the existing components of the non-locking differential as necessary to receive a locking component;
(iii) fitting a locking component moveable between an inoperative position in which said differential is not locked and an operative position in which said differential is locked;
(iv) fitting an actuator for moving said locking component from its inoperative position to its operative position;
(v) operably connecting said actuator to said locking component; and
(vi) mounting a differential pan which accommodates said actuator on said differential housing.

55. A method according to claim 54, further comprising the step of attaching a new mounting ring on the differential housing to receive the differential pan which accommodates the actuator.

56. A method according to claim 55, in which the mounting ring is attached to the rear of the axle assembly by welding.

57. A method according to claim 54, in which a mechanical actuator device is mounted inside the shaped ring, parallel to the half shaft to operate the locking device which actuator is connected to a fork, which in turn communicates reciprocal movement which engages/disengages a sliding dog gear, splined to the half shaft, into a splined bearing journal located in the differential carrier.

58. A method according to claim 54, in which the actuator is a solenoid.

59. A method according to claim 55, in which there are mounting studs used to create a space between mounting ring and axle assembly suitable for welding.
